(19) United States
(12) Patent Application Publication
(10) Pub. No.: US 2015/0022558 A1
(43) Pub. Date: Jan. 22, 2015

(54) Orientation Control For a Mobile Computing Device Based On User Behavior

(71) Applicant: Eric Li, Dallas, TX (US)

(72) Inventor: Eric Li, Dallas, TX (US)

(21) Appl. No.: 13/945,817

(22) Filed: Jul. 18, 2013

(51) Int. Cl. G09G 5/38; G06F 3/041

(52) U.S. Cl. CPC G09G 5/38; G06F 3/041
USPC 345/650; 345/173

(57) ABSTRACT

The present disclosure involves a method of orientation control. Media content is displayed via a screen of a mobile computing device. The media content is displayed in a first orientation mode. A first satisfaction of a predefined condition is detected. In response to the detected first satisfaction of the predefined condition, the media content is displayed in a second orientation mode different from the first orientation mode. One of the first and second orientation modes is portrait, the other one of the first and second orientation modes is landscape. A second satisfaction of the predefined condition is detected immediately after the media content has been displayed in the second orientation mode. In response to the detected second satisfaction of the predefined condition, the media content is displayed in the first orientation mode. Thereafter, the predefined condition is adjusted in a manner so that it is more difficult to satisfy.

### BACKGROUND

1. Technical Field

The present disclosure generally relates to configuring the display of media content on a mobile computing device.

2. Related Art

In recent years, the rapid advances in computer technology and broadband telecommunications have enhanced the popularity of mobile computing devices such as tablet computers and mobile telephones. Among other uses, these mobile computing devices have been often used to view or consume media content such as webpages, pictures, or videos. However, existing mobile computing devices may still have certain drawbacks with respect to viewing or displaying the media content. For example, most mobile computing devices can display media content in either a portrait orientation mode or a landscape orientation mode. The user may select the appropriate orientation mode to display the media content according to the user's preferences. However, from time to time, the user may inadvertently switch to an undesirable display orientation mode and would thereafter have to switch back to the previous orientation mode. This may frustrate the user. On the other hand, if the user chooses to “lock” the display orientation mode, then when the user truly needs to switch to a different orientation mode, he/she has to “unlock” the display orientation mode and then perform the switching. This is a cumbersome process and may frustrate the user as well.

Therefore, while existing mobile computing devices have been generally adequate for their intended purposes, they have not been entirely satisfactory in every aspect. It would be advantageous to add, among other things, more intuitive orientation detection and switching capabilities to mobile computing devices.

### BRIEF DESCRIPTION OF THE DRAWINGS

FIGS. 1-5 are example diagrammatic views of a mobile computing device according to various aspects of the present disclosure.

FIGS. 6-7 are example flowcharts illustrating methods for orientation control of a mobile computing device according to various aspects of the present disclosure

FIG. 8 is a simplified block diagram of an example mobile computing device according to various aspects of the present disclosure.

FIG. 9 is simplified block diagram of various embodiments of a system according to various aspects of the present disclosure.

### DETAILED DESCRIPTION

It is to be understood that the following disclosure provides many different embodiments, or examples, for implementing different features of the present disclosure. Specific examples of components and arrangements are described below to simplify the present disclosure. These are, of course, merely examples and are not intended to be limiting. Various features may be arbitrarily drawn in different scales for simplicity and clarity. In addition, the present disclosure may repeat reference numerals and/or letters in the various examples. This repetition is for the purpose of simplicity and clarity and does not in itself dictate a relationship between the various embodiments and/or configurations discussed

As used herein, the term “about” refers to a +/−5% variation from the nominal value. As used herein, the term “and/or” includes any and all combinations of one or more of the associated listed items. As used herein, the singular forms “a”, “an”, and “the” are intended to include the plurality forms as well, unless the context clearly and specifically indicates otherwise. In addition, unless defined otherwise, all technical and scientific terms used herein have the same meaning as commonly understood by one of ordinary skill in the art to which this disclosure belongs.

In recent years, the rapid advances in computer technology and broadband telecommunications have led to the growing popularity of mobile computing devices such as tablet computers and mobile telephones. A user of these mobile computing devices can perform a plurality of tasks on these mobile computing devices, for example tasks that previously required a conventional desktop or laptop computer. Among other things, a user can play movies/videos, browse the web, play games, view photographs, listen to digital music, read e-books, receive navigational instructions, send and receive emails, conduct audio or video telephone calls, perform word processing/spreadsheet calculation/presentation management tasks, or take advantage of additional functionalities offered by applications (apps) that can be downloaded from online app stores.

However, the mobile computing devices may still have certain drawbacks. For example, the screen display of most mobile computing devices are shaped similar to a rectangle and therefore allow media content such as a webpage to be displayed either in a portrait orientation mode or in a landscape orientation mode. To switch between these two orientation modes, conventional mobile computing devices use sensors such as accelerometers to detect the manner in which the mobile computing device is positioned, so that a corresponding orientation mode can be applied. The mobile computing device adjusts the display of the media content to comply with a user-specified orientation. However, the user may from time to time inadvertently trigger a switching of the display orientation, for example by tilting (e.g., while reading or browsing) the mobile computing device by an amount sufficient to trigger a display orientation switch. When this happens, the user would have to manipulate the mobile computing device in a manner to switch back to the previous orientation. Such inadvertent switching between the display orientations may be frustrating to the user.

To prevent inadvertent orientation switching, the user may also “lock” the display orientation mode for the mobile computing device. Once locked, the mobile computing device will not inadvertently switch from one display orientation to another. However, if the user is presented with a different media content that is better suited for another orientation, the user may have to first unlock the display orientation, then switch to the other orientation (for example by rotating the mobile computing device), and thereafter lock the display orientation again after the new target orientation mode has been achieved. This is a cumbersome and repetitive process and may lead to a frustrating user experience as well.

To overcome these issues discussed above, the present disclosure offers methods and apparatuses for orientation control based on monitored user behavior, as discussed in more detail below.

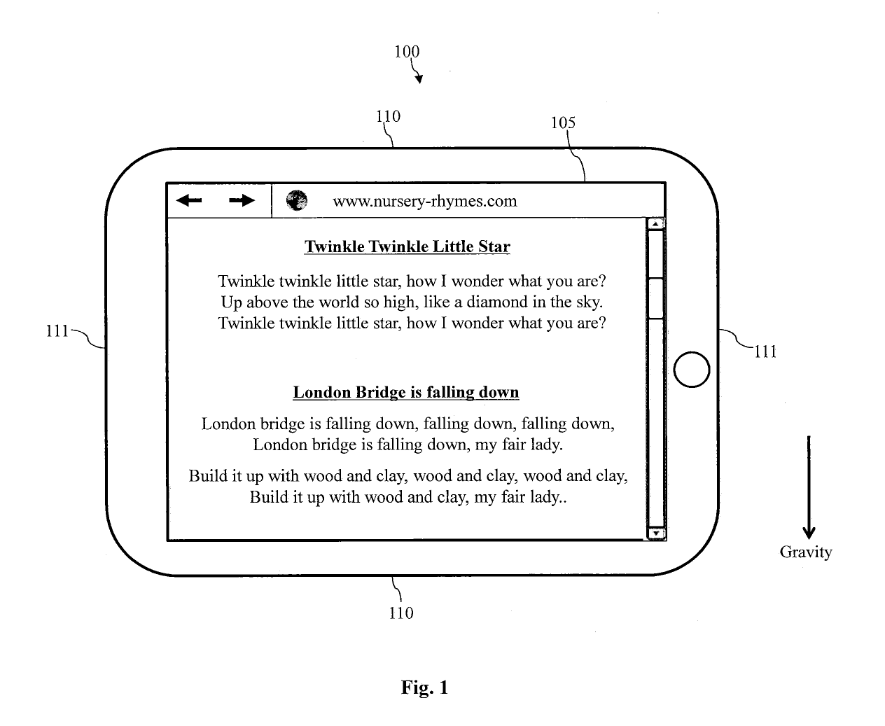

Referring to FIG. 1, a simplified diagrammatic view of a mobile computing device 100 is illustrated. In some embodiments, the mobile computing device 100 may be a tablet computer (for example, APPLE's® IPAD® or various ANDROID or WINDOWS 8 powered tablets). In another embodiment, the mobile computing device 100 may be a mobile telephone (for example, APPLE's® IPHONE® or various ANDROID® or WINDOWS® powered smart-phones). In further embodiments, the mobile computing device 100 may include laptop computers. In yet other embodiments, the mobile computing device 100 may include wearable devices such as an electronic watch.

A display screen 105 (also interchangeably referred to as a display 105 or screen 105 thereafter) of the mobile computing device 100 may be approximately shaped as a rectangle, in that it has two long sides 110 and two short sides 111. As such, the mobile computing device may be oriented in either a landscape orientation mode (e.g., a long side 110 at the bottom) or a portrait orientation mode (e.g., a short side 111 at the bottom). In the embodiment shown in FIG. 1, the mobile computing device 100 is in a landscape orientation mode.

In some embodiments, the screen 105 of the mobile computing device 100 may be a touch-sensitive screen configured to display media content. However, it is understood that the various aspects of the present disclosure may apply to a non-touch screen display as well. For example, whereas a touch screen device may detect user input via sensing the contact and the movement of the user's fingers or a stylus (or another suitable object) on the screen 105, a non-touch screen device may detect user input via more traditional mechanisms such as a mouse, a keyboard, a remote control, a gesture, a stylus, or voice commands.

The media content displayed on the mobile computing device may include, but is not limited to, webpages, digital pictures, digital videos, electronic books, or a home screen of the mobile computing device, where the home screen specifies the layout of a plurality of icons. In the embodiment illustrated in FIG. 1, the mobile computing device 100 receives a request (for example from a user) to display an example webpage www.nursery-rhymes.com as the media content. The contents of the web page are displayed on the screen 105 of the mobile computing device via a web browser. As non-limiting examples, the request may be received when the user inputs the target Universal Resource Locator (URL) link to an address bar of the web browser, or when the user clicks on a link in another web page. For the sake of providing an example, the words of two well-known nursery rhymes “Twinkle twinkle little star” and “London bridge is falling down” are shown as a portion of the example webpage.

In the embodiment shown in FIG. 1, the mobile computing device 100 is configured to display the media content (i.e., the webpage) in a landscape orientation mode. This is done in response to a request from a user. The user may specify the landscape orientation mode as a desired orientation mode by interacting with the mobile computing device 100 in a certain manner. For example, the mobile computing device 100 may include one or more sensors, such as a gravity sensor or an accelerometer. Suppose the mobile computing device 100 is held by the user in a position such that one of the long sides 110 is closer to the ground (where the gravity is pulling the mobile computing device 100 toward the ground, as indicated by the downward arrow). The mobile computing device 100 may detect this position of the mobile computing device 100 via its sensors. The mobile computing device 100 may interpret the user action as that the user would like to display the media content in the landscape orientation mode. Thus, the mobile computing device 100 displays the media content (the webpage) in the landscape orientation mode.

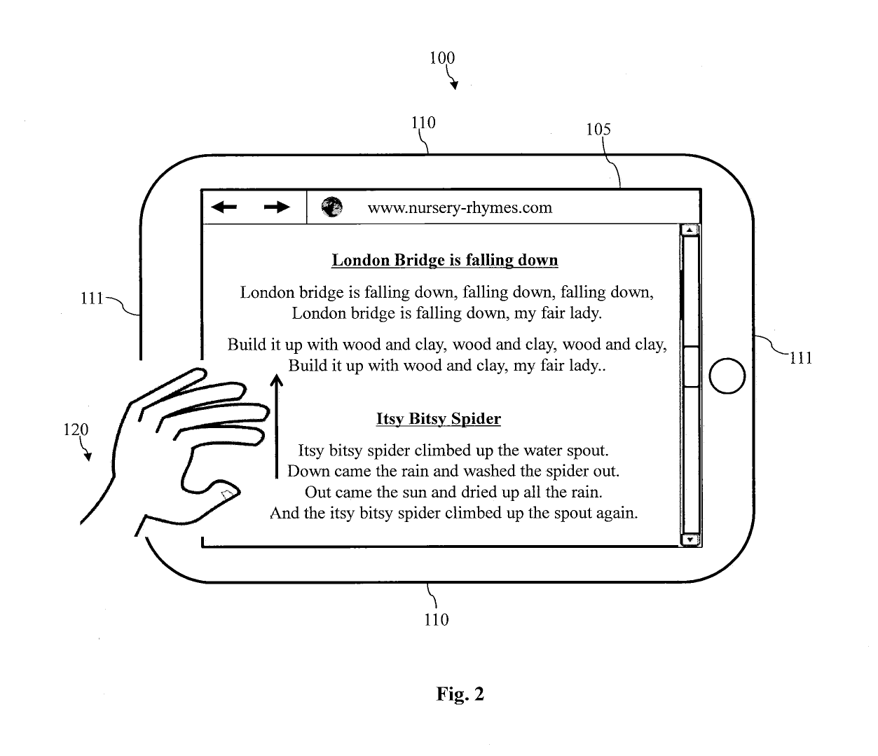

According to the various aspects of the present disclosure, the mobile computing device 100 also determines an intended flow direction of the media content being displayed. The intended flow direction of the media content refers to the direction in which the media content is meant to “flow” or is move as the media content is being consumed. In this web page example illustrated in FIG. 1, the intended flow direction is a vertical direction (i.e., up or down). That is, the user scrolls the web page displayed by the mobile computing device 100 by “moving” the web page upwards or downwards. This may be done via a touch input by the user. For example, referring to FIG. 2, the user may use his/her hand 120 to touch and hold the screen 105 and then move the hand 120 up (as indicated by the arrow drawn on the screen 105) to scroll down the web page being displayed. As a result, a new nursery rhyme “Isty Bitsy Spider” below the nursery rhyme “London Bridge is falling down” is now being displayed on the screen 105, and the nursery rhyme “London Bridge is falling down” is moved up the screen 105. In other embodiments, the user may use a stylus or a gesture that does not necessarily involve making a physical contact with the screen 105 (e.g., a wave of the hand) to scroll through the web page.

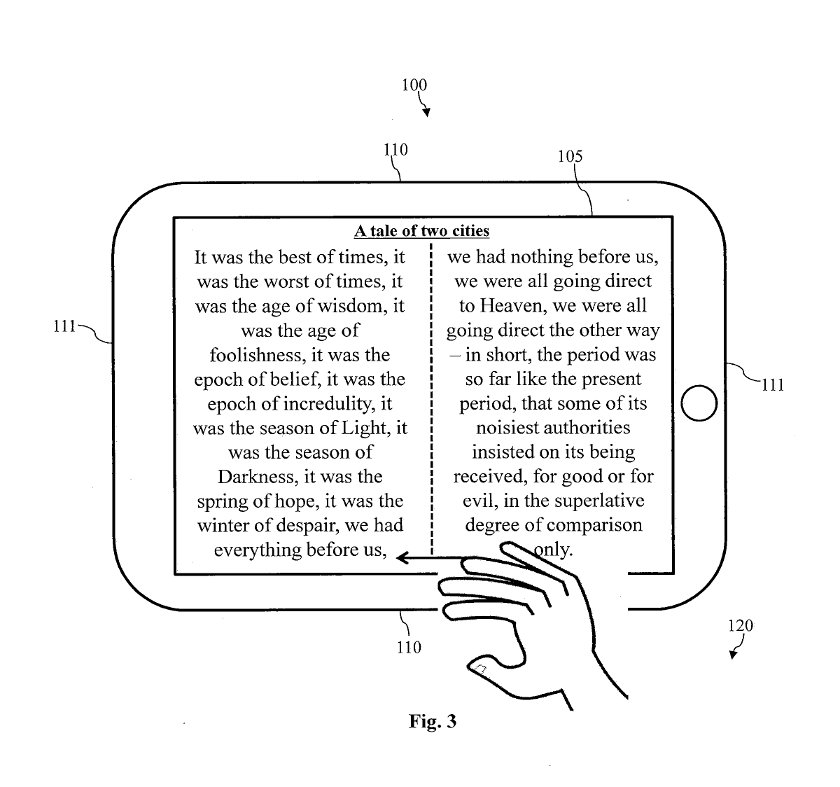

FIG. 3 illustrates an electronic book displayed on the screen 105 of the mobile computing device 100 as another example of media content being consumed. In the embodiment shown in FIG. 3, the electronic book is an excerpt from “A tale of two cities”. The electronic book is implemented so that the user may flip to a previous page to the left or a next page to the right. In that sense, the intended flow direction of the electronic book is a horizontal direction. The user may navigate to the desired page of the book by engaging the screen 105 with the hand 120 (or another suitable input mechanism) and swiping the book to the right or left with the hand.

Regardless of the type of media content, the user inputs for navigating through the media content are also recorded by the mobile computing device 100. As shown by the examples in FIGS. 2-3, these user inputs each have a directional component. In the example of browsing through a web page of FIG. 2, the user inputs for navigating through the web page each have a vertical directional component, as that example web page is designed to be scrolled up or down. In the example of reading an electronic book of FIG. 3, the user inputs for navigating through the electronic book each have a horizontal directional component, as the electronic book is designed to be read in virtual pages arranged from left to right.

In some embodiments, the mobile computing device 100 is configured to automatically associate certain types of media display applications with a particular intended flow direction by default. For example, a web browser application may automatically be associated with a vertical intended flow direction, and an electronic book may automatically be associated with a horizontal intended flow direction. In other embodiments, rather than making default associations, the mobile computing device 100 analyzes the user navigation behavior (with respect to consuming the media content) for each type of media display application. After enough data is collected, the mobile computing device 100 can then make a relatively accurate guess or estimated as to the intended flow direction for that type of application. As an example, even if the mobile computing device 100 does not “know” that the intended flow direction for an electronic book (such as that illustrated in FIG. 3) is supposed to be a horizontal direction, it may eventually “figure it out” after detecting that the user always swipes horizontally to go to the previous or subsequent pages.

It is understood that the specific display orientation mode of the mobile computing device 100 while the media content is displayed does not affect the intended flow direction of the media content. In other words, the web page in FIG. 2 still should be scrolled up or down regardless of whether the mobile computing device 100 is in a portrait display orientation mode or in a landscape display orientation mode, and the virtual pages of the electronic book in FIG. 3 still should be flipped from left or right regardless of whether the mobile computing device 100 is in a portrait display orientation mode or in a landscape display orientation mode.

After the intended flow direction of the media content is determined, and after a number of these user inputs are recorded, the mobile computing device 100 may make a determination as to a common or predominant directional component for these user inputs. For instance, when the user is browsing the web page of FIG. 2, most of the user inputs for navigating through the web page should have a vertical directional component. As an example, a few of these user inputs may be substantially vertical (e.g., close to 90 degrees), a few more of these user inputs may vary more from a straight vertical line but may still be predominantly vertical (e.g., in a range from about 50 degrees to about 85 degrees). Some of these user inputs may be curved or non-straight, but they may still have an overall direction that is close to the 90 degree vertical direction. There might be a few user inputs that do not have a predominantly vertical direction. For example, these user inputs may be a pinch-to-zoom operation which is not inherently direction-specific. As another example, some of these user inputs may even have a predominantly horizontal directional component, in situations where the screen 105 does not show all of the media content (i.e., the media content is too zoomed-in), and thus the user may have to scroll to the left or right occasionally to see additional omitted media content not displayed on the screen 105. Nevertheless, the majority of the user navigational inputs should have a predominantly vertical directional component to them since the user has to scroll up or down to properly browse the web page. Similarly, in the electronic book example in FIG. 3, most of the user navigational inputs should have a predominantly horizontal directional component, since the user would have to swipe left or right on the screen 105 to go to the previous virtual page or the next virtual page.

It is understood that the directional components of the user inputs are defined with respect to the screen 105. For example, when the mobile computing device 100 is in the landscape display orientation mode, user swiping gestures made mostly toward one of the long sides 110 (e.g., perpendicular to the long side 110) are deemed to be vertical swiping gestures. Alternatively stated, these gestures have a predominantly vertical directional component. On the other hand, user swiping gestures made mostly toward one of the short sides 111 (e.g., perpendicular to the short side 111) are deemed to be horizontal swiping gestures. Alternatively stated, these gestures have a predominantly horizontal directional component. Conversely, when the mobile computing device 100 is in the portrait display orientation mode, user swiping gestures made mostly toward one of the long sides 111 are deemed to be vertical swiping gestures (and therefore have a predominantly vertical directional component), and user swiping gestures made mostly toward one of the short sides 110 are deemed to be horizontal swiping gestures (and therefore have a predominantly horizontal directional component).

If the common or predominant directional component of the user navigational inputs are consistent with the intended flow direction of the media content, that is an indication that the current display orientation mode of the mobile computing device 100 is one preferred by the user, at least for the time being. This means that, in the absence of a definitive event that indicates otherwise, the current display orientation mode of the mobile computing device 100 should be retained for continued displaying of the media content. In other words, if the user is browsing a web page, and say over 90% of the user navigation inputs have a predominantly vertical direction, that means the current display orientation mode (be it the portrait mode or the landscape mode) is fine with the user and should not be switched unless the mobile computing device 100 is absolutely sure that the user wants to switch the display orientation mode.

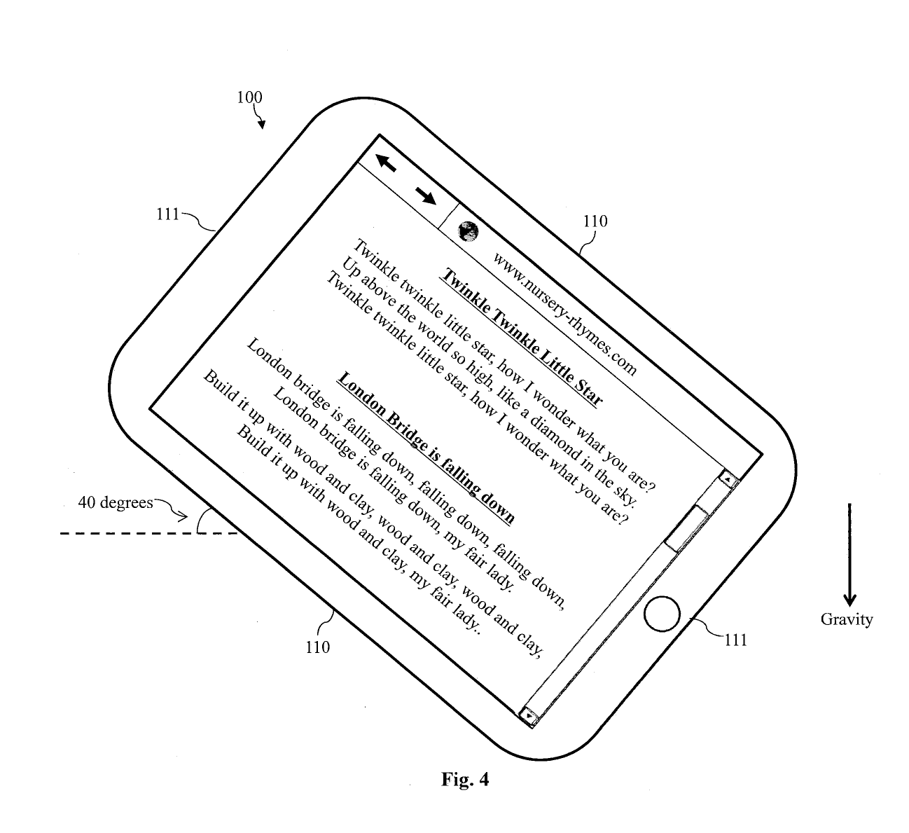

According to the various aspects of the present disclosure, assuming that the display orientation has not been “locked”, switching from one display orientation mode to another requires the satisfaction of a condition. In some embodiments, the condition includes a tilt (or a degree of tilt, or a tilting angle) of the mobile computing device 100. When the tilt of the mobile computing device 100 exceeds a predefined threshold, that condition is deemed to be satisfied, and the display orientation modes are switched. For example, referring to FIG. 4, the mobile computing device 100 is tilted at an angle that is approximately 40 degrees, which may be measured by sensors (e.g., accelerometers) on the mobile computing device 100. Suppose the predefined threshold corresponds to a tilt angle of 60 degrees, then the condition for switching to a different display orientation mode is not satisfied yet, and as such the mobile computing device 100 remains in the landscape display orientation mode.

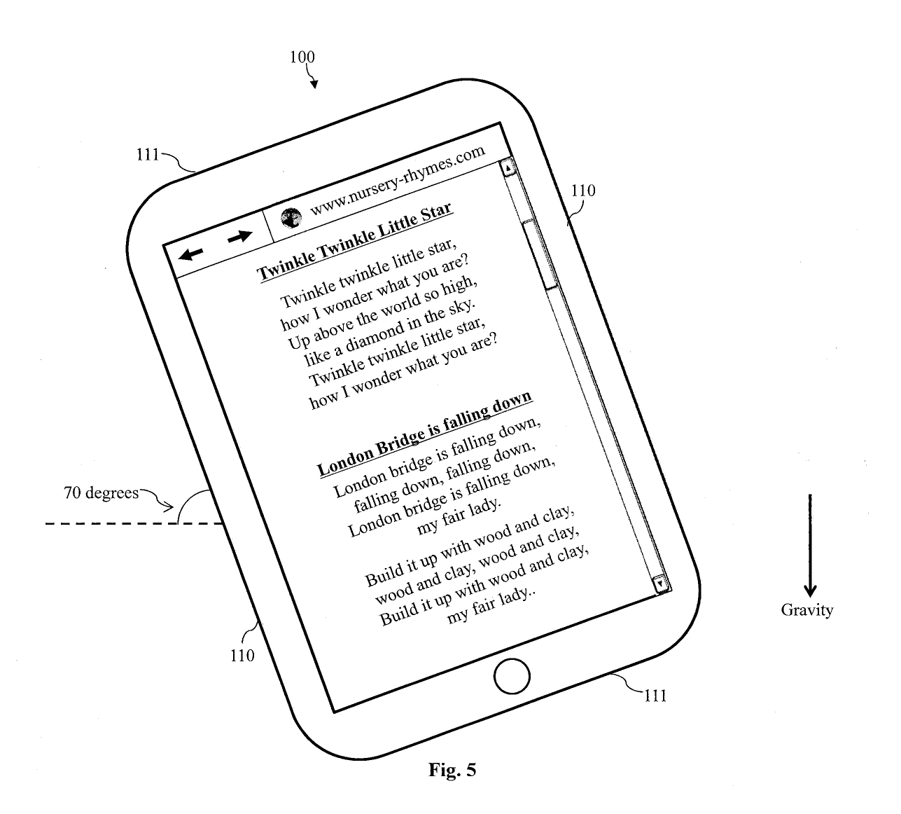

Referring now to FIG. 5, the mobile computing device 100 is now tilted at an angle that is approximately 70 degrees. This exceeds the predefined threshold tilt angle (may be interchangeably referred to as “threshold” hereinafter) of 60 degrees required for switching the display orientation modes. The mobile computing device 100 determines that the condition for the display orientation switching has been satisfied and therefore switches from the landscape display orientation mode to the portrait display orientation mode.

According to the various aspects of the present disclosure, the condition is adjusted in response to the monitored user behavior, such as the plurality of user navigation inputs. In more detail, if the condition is a static condition (unadjusted), the satisfaction of the condition corresponds to a constant or static threshold being met. If that is the case, then in the example above, the display orientation modes are switched every time the tilt angle of the mobile computing device 100 exceeds 60 degrees. While 60 degrees may sound significant, it actually may not be in real life situations, and therefore can be easily met inadvertently. For example, if the user is laying down on a bed or sofa while browsing a web page or reading an electronic book, he/she may inadvertently tilt the mobile computing device 100 more than 60 degrees and therefore trigger the switching of the display orientation modes. As another example, the user may be sitting on a toilet while holding a smartphone (an example of the mobile computing device 100) one-handed to view the media content on the smartphone. Since the smartphone is held one-handed, the user may inadvertently tilt the smartphone more than 60 degrees while holding it. Again, that will trigger the switching of the display orientation mode without the user really meaning to do so.

To address the inadvertent switching problem, the mobile computing device 100 of the present disclosure adjusts the condition for switching based on the common directional component of the user inputs as monitored. Thus, the condition for switching is dynamic and is correlated with user behavior. According to certain embodiments, the condition (for switching) is adjusted so that it is more difficult to be satisfied if the common directional component of the user inputs are consistent with the intended flow direction of the displayed media content. As discussed above, if the common directional component of the user inputs is consistent with the intended flow direction of the displayed media content, that is a reliable indication that the user is happy with the present display orientation mode of the mobile computing device 100. Therefore, unless there is an indication with a very high confidence level that the user truly does wish to switch to a different display orientation mode, the current display orientation mode should not be switched. In such case, the predefined original threshold tilt angle of 60 degrees in the example above does not constitute an indication with a very high confidence level for switching. Therefore, the mobile computing device 100 increases the threshold to a higher threshold, for example by changing the threshold tilt angle from 60 degrees to 75 degrees. Now, even if the mobile computing device 100 is tilted to 70 degrees inadvertently, the display orientation modes will not be switched. Of course, 70 degrees is merely used as an illustrative example herein, and other numbers may be used in other embodiments.

In some embodiments, the adjustment to the condition as discussed above may be made continuously based on the monitored user behavior. For example, if the predominant direction of the user navigational inputs is determined to be consistent with the intended flow direction of the media content for the last 10 minutes, then the threshold for switching the display orientation modes may be increased from 60 degrees to 65 degrees. The mobile computing device 100 may continue to monitor the user inputs for the next 10 minutes, and if the predominant direction of the user navigational inputs for the next 10 minutes are also determined to be consistent with the intended flow direction of the media content for the next 10 minutes, then the threshold for switching the display orientation modes may be increased from 65 degrees to 70 degrees. This process may be repeated until a predetermined upper limit for the threshold has been reached, for example 80 degrees (i.e., the threshold for switching the display orientation mode cannot be set higher than 80 degrees, which may be another predefined number in various other embodiments).

In certain embodiments, the adjustment to the condition as discussed above may also be made as a function of the frequency of the user inputs. For example, within a given time period of monitoring, if the user has made many navigational inputs that have the predominant direction that is consistent with the intended flow direction of the media content, then the threshold for satisfying the condition is increased at a greater amount. In the example discussed above, the threshold may be increased from 60 degrees to 70 degrees, rather than 65 degrees, if the user has made many navigational inputs whose predominant direction is consistent with the intended flow direction of the media content. This is because the fact that numerous user inputs all have the same predominant direction is a very reliable indicator that the user appears to be happy with the current display orientation mode and does not wish to switch to a different display orientation mode. On the other hand, if the user has only made a few navigational inputs whose predominant direction is consistent with the intended flow direction of the media content, the threshold may be increased from 60 degrees to only 65 degrees, or not increased at all. This is because the fact that only a few user inputs have the same predominant direction is a relatively poor indicator as to whether the user is happy with the current display orientation mode.

In any case, since the condition is modified so that it is harder to be satisfied, the eventual satisfaction of the condition is a very reliable indication that the user indeed wants to switch to different display orientation mode. Once the orientation mode is switched, the condition is reset to the original condition. As an example, suppose that the threshold for switching may have been adjusted from 60 degrees (i.e., the original threshold) to 80 degrees based on the user input behavior as discussed above. The mobile computing device 100 then detects that it has been tilted at about a 90 degree angle, thereby triggered the meeting of the new threshold. As a result, the mobile computing device 100 switches to a different display orientation mode. The threshold for switching is reset from 80 degrees back to 60 degrees again. At this point, the threshold may again be adjusted to different numbers based on the pattern and behavior of user inputs as discussed above.

According to other aspects of the present disclosure, the condition for orientation switching may be adjusted based on factors other than the directionality of the user engagement with the screen 105 of the mobile computing device 100. For example, the condition for orientation switching may be adjusted based on user actions immediately after an orientation switching event. In more detail, suppose the condition for switching specifies a threshold tilt angle of 60 degrees while the mobile computing device is displaying media content such as web page, an electronic book, a picture, a video, a game, etc. The mobile computing device 100 then detects that it has been tilted at an angle exceeding 60 degrees. Consequently, the mobile computing device 100 switches to a different mode of display orientation (for example from landscape to portrait, or vice versa). However, immediately (e.g., within a few seconds or less) after the display orientation mode has been switched, the mobile computing device 100 detects that the condition for switching has been satisfied again. In other words, the mobile computing device 100 detects that the user wants to switch back to the previous display orientation mode. The mobile computing device 100 therefore switches back to the original display orientation mode.

This sequence of events described above is a reliable indicator that the first satisfaction of the condition (i.e., the detected orientation switching for the first time) is inadvertent. This is evidenced by the fact that the user wishes to switch back to the original display orientation mode right away after the initial switch. Thus, according to the various aspects of the present disclosure, the mobile computing device 100 will adjust the condition for orientation switching so that it is more difficult to be met (e.g., increasing the threshold tilt angle), so as to prevent additional inadvertent orientation switches in the future. For example, the initial threshold tilt angle may be adjusted from 60 degrees to 70 degrees. As such, the higher threshold tilt angle is harder to be inadvertently exceeded, and this will reduce future inadvertent orientation switches. Of course, once the condition is satisfied again thereafter—which triggers an orientation switch—and the mobile computing device 100 does not immediately detect a request to switch back to the previous display orientation, that is an indication that the user wishes to stay at the new orientation for the time being. The condition for switching may therefore be reset back to the original condition (e.g., the threshold tilt angle is reset from 70 degrees back to 60 degrees).

It is understood that the detecting the directionality of user inputs aspect of the present disclosure may be combined with the detecting orientation switching immediately after an orientation switching event aspect of the present disclosure. In other words, the condition for switching orientation displays may be adjusted as a function of the detected directionality of the user navigational inputs, or as a function of how soon (if at all) the display orientation is switched back after having been switched for the first time, or both.

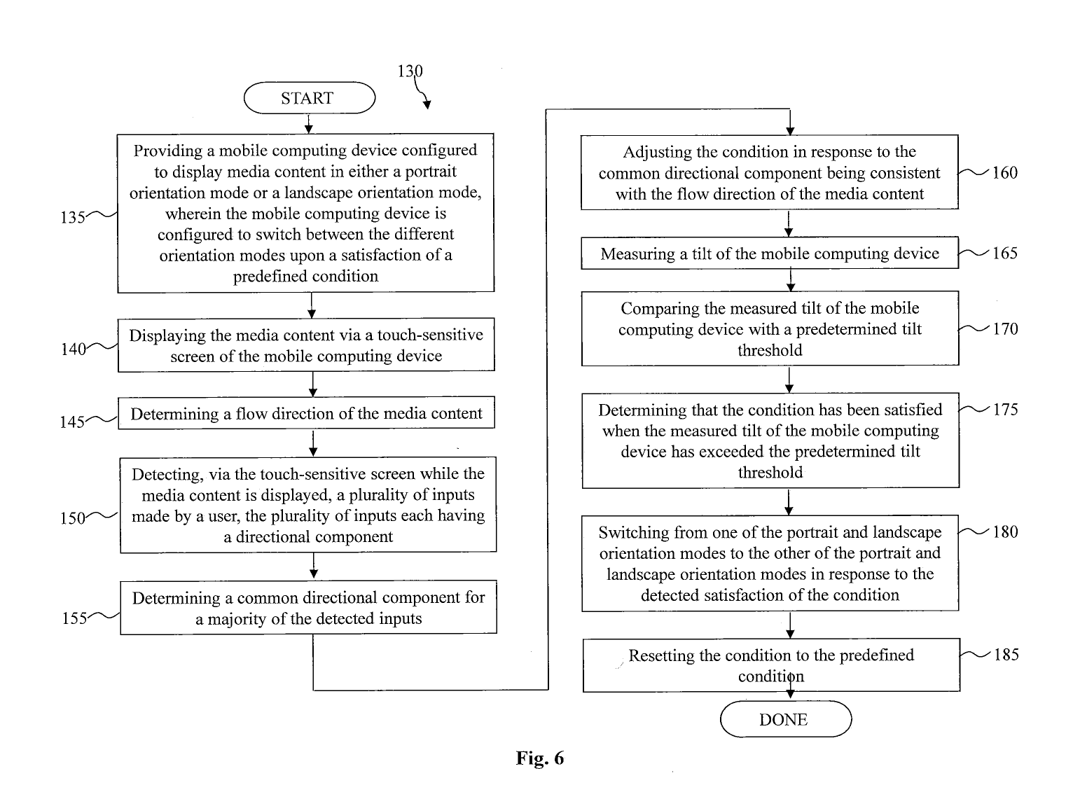

FIG. 6 is a flowchart of a simplified method 130 of orientation control for a mobile computing device according to an embodiment.

The method 130 includes a step 135 of providing a mobile computing device configured to display media content in either a portrait orientation mode or a landscape orientation mode. The mobile computing device is configured to switch between the different orientation modes upon a satisfaction of a predefined condition.

The method 130 includes a step 140 of displaying the media content via a touch-sensitive screen of the mobile computing device. In some embodiments, the step of displaying the media content includes displaying a web page or an electronic book.

The method 130 includes a step 145 of determining a flow direction of the media content.

The method 130 includes a step 150 of detecting, via the touch-sensitive screen while the media content is displayed, a plurality of inputs made by a user. The plurality of inputs each have a directional component. In some embodiments, the inputs include swiping gestures.

The method 130 includes a step 155 of determining a common directional component for a majority of the detected inputs. In some embodiments, the step of determining the common directional component is performed with respect to the detected inputs after a most recent switching of the orientation mode.

The method 130 includes a step 160 of adjusting the condition in response to the common directional component being consistent with the flow direction of the media content. In some embodiments, the step 160 of adjusting the condition includes making the satisfaction of the condition more difficult.

The method 130 includes a step 165 of measuring a tilt of the mobile computing device.

The method 130 includes a step 170 of comparing the measured tilt of the mobile computing device with a predetermined tilt threshold.

The method 130 includes a step 175 of determining that the condition has been satisfied when the measured tilt of the mobile computing device has exceeded the predetermined tilt threshold. In some embodiments, the step 160 of adjusting the condition includes a step of increasing the predetermined tilt threshold so that it is more difficult to be exceeded.

The method 130 includes a step 180 of switching from one of the portrait and landscape orientation modes to the other of the portrait and landscape orientation modes in response to the detected satisfaction of the condition. The switch is performed after the satisfaction of the condition has been detected after the condition has been adjusted in the step 160.

The method 130 includes a step 185 of resetting the condition to the predefined condition after the orientation switching is performed in step 180.

It is understood that the method 130 may include additional steps performed before, during, or after the steps 135-185 discussed above. For example, the method 130 may further include the following steps: detecting the satisfaction of the condition while the media content is displayed at a first orientation mode, the first orientation mode being one of the portrait orientation mode and the landscape orientation mode; displaying, in response to the satisfaction of the condition, the media content in a second orientation mode different from the first orientation mode, the second orientation mode being another one of the portrait orientation mode and the landscape orientation mode; detecting, within a predetermined amount of time after the media content is displayed in the second orientation mode, a satisfaction of the condition to switch from the second orientation mode back to the first orientation mode; and thereafter performing the following: displaying the media content in the first orientation mode; and adjusting the condition in a manner so that the switching from the first orientation mode to the second orientation mode is more difficult. In some embodiments, the predetermined amount of time is less than a few seconds.

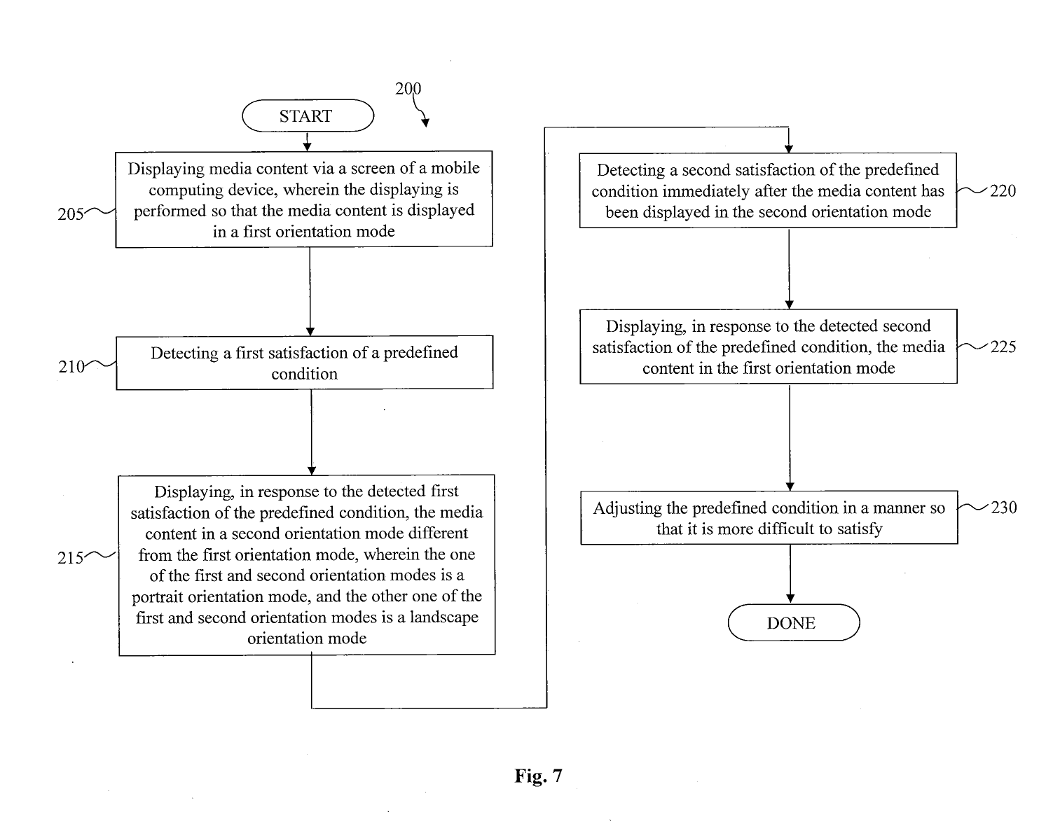

FIG. 7 is a flowchart of a simplified method 200 of orientation control for a mobile computing device according to an embodiment. In some embodiments, the mobile computing device is a smartphone or a tablet computer each having a touch-sensitive user interface.

The method 200 includes a step 205 of displaying media content via a screen of a mobile computing device. The displaying is performed so that the media content is displayed in a first orientation mode. In some embodiments, the media content includes a web page, an electronic book, a picture, a video, or a game. The method 200 includes a step 210 of detecting a first satisfaction of a predefined condition. In some embodiments, the predefined condition specifies a threshold tilt angle of the mobile computing device. The method 200 includes a step 215 of displaying, in response to the detected first satisfaction of the predefined condition, the media content in a second orientation mode different from the first orientation mode. One of the first and second orientation modes is a portrait orientation mode, and the other one of the first and second orientation modes is a landscape orientation mode. In some embodiments, the satisfaction of the predefined condition includes detecting that the mobile computing device has been tilted at an angle that exceeds the threshold tilt angle of the mobile computing device. The method 200 includes a step 220 of detecting a second satisfaction of the predefined condition immediately after the media content has been displayed in the second orientation mode. The method 200 includes a step 225 of displaying, in response to the detected second satisfaction of the predefined condition, the media content in the first orientation mode. The method 200 includes a step 230 of adjusting the predefined condition in a manner so that it is more difficult to satisfy.

It is understood that the method 200 may include additional steps performed before, during, or after the steps 205-230 discussed above. For reasons of simplicity, these additional steps are not discussed herein.

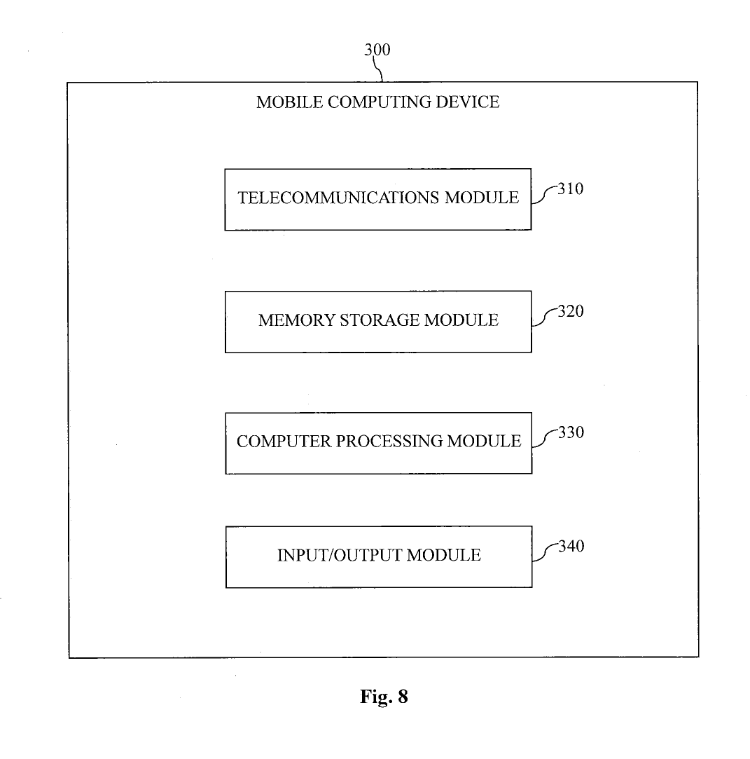

FIG. 8 is a simplified block diagram of a mobile computing device 300 according to the various aspects of the present disclosure. The mobile computing device 300 may be implemented as an embodiment of the mobile computing device 100 discussed above.

The mobile computing device 300 includes a telecommunications module 310. The telecommunications module 310 contains various electronic circuitry components configured to conduct telecommunications with one or more external devices. The electronic circuitry components allow the telecommunications module 310 to conduct telecommunications in one or more of the wired or wireless telecommunications protocols, including communications protocols such as IEEE 802.11 (WiFi), IEEE 802.15 (Bluetooth), GSM, CDMA, LTE, WIMAX, DLNA, HDMI, etc. In some embodiments, the telecommunications module 310 includes antennas, filters, low-noise amplifiers, digital-to-analog (DAC) converters, analog-to-digital (ADC) converters, and transceivers. The transceivers may further include circuitry components such as mixers, amplifiers, oscillators, phase-locked loops (PLLs), and/or filters. Some of these electronic circuitry components may be integrated into a single discrete device or an integrated circuit (IC) chip.

The mobile computing device 300 may include a computer memory storage module 320. The memory storage module 320 may contain various forms of digital memory, such as hard disks, FLASH, SRAM, DRAM, ROM, EPROM, memory chips or cartridges, etc. Computer programming code may be permanently or temporarily stored in the memory storage module 320, for example. In some embodiments, the computer memory storage module 320 may include a cache memory where files can be temporarily stored.

The mobile computing device 300 may also include a computer processing module 330. The computer processing module 330 may contain one or more central processing units (CPUs), graphics processing units (GPUs), or digital signal processors (DSPs), which may each be implemented using various digital circuit blocks (including logic gates such as AND, OR, NAND, NOR, XOR gates, etc) along with certain software code. The computer processing module 330 may be used to execute the computer programming code stored in the memory storage module 320.

The mobile computing device 300 may also include an input/output module 340, which may serve as a communications interface for the mobile computing device 300. In some embodiments, the input/output module 340 may include one or more touch-sensitive screens, physical and/or virtual buttons (such as power and volume buttons) on or off the touch-sensitive screen, physical and/or virtual keyboards, mouse, track balls, speakers, microphones, light-sensors, light-emitting diodes (LEDs), communications ports (such as USB or HDMI ports), joy-sticks, image-capture devices (for example cameras), etc. In some embodiments, the touch-sensitive screen may be used to display media content discussed above. The orientation switching according to the various embodiments discussed above may also be accomplished at least in part using the touch-sensitive screen and/or other components of the input/output module 340. In alternative embodiments, a non-touch screen display may be implemented as a part of the input/output module 340.

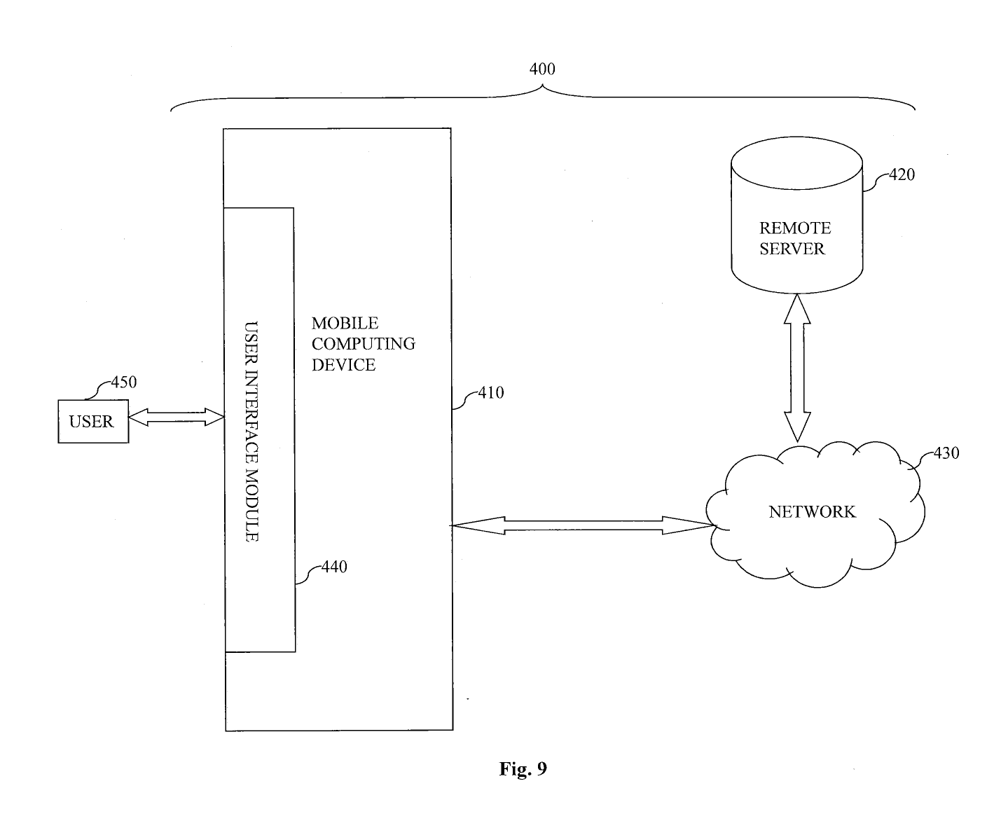

FIG. 9 is a simplified diagrammatic view of a system 400 that may be used to perform certain aspects of the orientation switching of the present disclosure discussed above. In some embodiments, the system 400 may include a mobile computing device 410. The mobile computing device 410 may be implemented as an embodiment of the mobile computing device 300 of FIG. 8. In some embodiments, the mobile computing device 410 includes a tablet computer or a mobile telephone.

The system 400 also includes a remote server 420. The remote server 420 may be implemented in a “cloud” computing environment and may include one or more databases that store files, for example the user preferences with respect to display orientations for a particular media content.

The mobile computing device 410 and the remote server 420 may be communicatively coupled together through a network 430. The network 430 may include cellular towers, routers, switches, hubs, repeaters, storage units, cabling (such as fiber-optic cabling or telephone cabling), and other suitable devices. The network 430 may be implemented using any of the suitable wired or wireless networking protocols. The mobile computing device 410 and the remote server 420 may also be able to communicate with other devices on the network 430 and either carry out instructions received from the network, or send instructions through the network to these external devices to be carried out.

To facilitate user interaction with its offered services, a service provider (that hosts or operates the remote server 420) may provide a user interface module 440. The user interface module 440 may include software programming code and may be installed on the mobile computing device 410 (for example in a memory storage module). In some embodiments, the user interface module 440 may include a downloadable “app”, for example an app that is downloadable through a suitable service such as APPLE's® ITUNES®, THE APP STORE CD from APPLE®, ANDROID's PLAY STORE®, AMAZON's INSTANT VIDEO®, MICROSOFT's WINDOWS STORE®, RESEARCH IN MOTION's BLACKBERRY APP WORLD®, etc. In the embodiment shown, the user interface module 440 includes an instance of the “app” that has been downloaded and installed on the mobile computing device 440. The app may also be used to estimate a user's preferences for display orientation, and to facilitate the subsequent display of that media content according to the user's preferences.

A user 450 may interact with the system 400 by sending instructions to the mobile computing device 410 through the user interface module 440. For example, the user 450 may be a subscriber of the services offered by the service provider running/hosting/operating the remote server 420. The user 450 may attempt to log in to the remote server 420 by launching the “app” of the user interface 440. The user's login credentials are electrically sent to the remote server 420 through the network 430. After verifying the user login credentials, the remote server 420 may instruct the user interface module 440 to display a suitable interface to interact with the user in a suitable manner.

One aspect of the present disclosure involves a mobile computing device. The mobile computing device includes: a communications interface configured to display information; a memory storage component configured to store computer programming code; and a computer processor configured to execute the computer programming code to perform the following steps: displaying media content via a touch-sensitive screen of a mobile computing device, wherein the mobile computing device is configured to display media content in either a portrait orientation mode or a landscape orientation mode, and wherein the mobile computing device is configured to switch between the different orientation modes upon a satisfaction of a predefined condition; determining a flow direction of the media content; detecting, via the touch-sensitive screen while the media content is displayed, a plurality of inputs made by a user, the plurality of inputs each having a directional component; determining a common directional component for a majority of the detected inputs; and adjusting the condition in response to the common directional component being consistent with the flow direction of the media content.

Another aspect of the present disclosure involves a method of orientation control. The method includes: displaying media content via a touch-sensitive screen of a mobile computing device, wherein the mobile computing device is configured to display media content in either a portrait orientation mode or a landscape orientation mode, and wherein the mobile computing device is configured to switch between the different orientation modes upon a satisfaction of a predefined condition; determining a flow direction of the media content; detecting, via the touch-sensitive screen while the media content is displayed, a plurality of inputs made by a user, the plurality of inputs each having a directional component; determining a common directional component for a majority of the detected inputs; and adjusting the condition in response to the common directional component being consistent with the flow direction of the media content.

Yet another aspect of the present disclosure involves a non-transitory computer readable medium comprising executable instructions that when executed by a processor, causes the processor to perform the steps of: displaying media content via a touch-sensitive screen of a mobile computing device, wherein the mobile computing device is configured to display media content in either a portrait orientation mode or a landscape orientation mode, and wherein the mobile computing device is configured to switch between the different orientation modes upon a satisfaction of a predefined condition; determining a flow direction of the media content; detecting, via the touch-sensitive screen while the media content is displayed, a plurality of inputs made by a user, the plurality of inputs each having a directional component; determining a common directional component for a majority of the detected inputs; and adjusting the condition in response to the common directional component being consistent with the flow direction of the media content.

One more aspect of the present disclosure involves a mobile computing device. The mobile computing device includes: a screen configured to display media content; a computer memory storage module configured to store executable computer programming code; and a computer processor module operatively coupled to the computer memory storage module, wherein the computer processor module is configured to execute the computer programming code to perform the following operations: displaying media content via the screen in a first orientation mode; detecting a first satisfaction of a predefined condition; displaying, in response to the detected first satisfaction of the predefined condition, the media content in a second orientation mode different from the first orientation mode, wherein the one of the first and second orientation modes is a portrait orientation mode, and the other one of the first and second orientation modes is a landscape orientation mode; detecting a second satisfaction of the predefined condition immediately after the media content has been displayed in the second orientation mode; displaying, in response to the detected second satisfaction of the predefined condition, the media content in the first orientation mode; and thereafter adjusting the predefined condition in a manner so that it is more difficult to satisfy.

Yet another aspect of the present disclosure involves a method. The method includes: displaying media content via a screen of a mobile computing device, wherein the displaying is preformed so that the media content is displayed in a first orientation mode; detecting a first satisfaction of a predefined condition; displaying, in response to the detected first satisfaction of the predefined condition, the media content in a second orientation mode different from the first orientation mode, wherein the one of the first and second orientation modes is a portrait orientation mode, and the other one of the first and second orientation modes is a landscape orientation mode; detecting a second satisfaction of the predefined condition immediately after the media content has been displayed in the second orientation mode; displaying, in response to the detected second satisfaction of the predefined condition, the media content in the first orientation mode; and thereafter adjusting the predefined condition in a manner so that it is more difficult to satisfy.

Yet one more aspect of the present disclosure involves a non-transitory computer readable medium comprising executable instructions that when executed by a processor, causes the processor to perform the steps of: displaying media content via a screen of a mobile computing device, wherein the displaying is performed so that the media content is displayed in a first orientation mode; detecting a first satisfaction of a predefined condition; displaying, in response to the detected first satisfaction of the predefined condition, the media content in a second orientation mode different from the first orientation mode, wherein the one of the first and second orientation modes is a portrait orientation mode, and the other one of the first and second orientation modes is a landscape orientation mode; detecting a second satisfaction of the predefined condition immediately after the media content has been displayed in the second orientation mode; displaying, in response to the detected second satisfaction of the predefined condition, the media content in the first orientation mode; and thereafter adjusting the predefined condition in a manner so that it is more difficult to satisfy.

It should be appreciated that like reference numerals in the present disclosure are used to identify like elements illustrated in one or more of the figures, wherein these labeled figures are for purposes of illustrating embodiments of the present disclosure and not for purposes of limiting the same.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method, comprising:
displaying media content via a touch-sensitive screen of a mobile computing device, wherein the mobile computing device is configured to display media content in either a portrait orientation mode or a landscape orientation mode, and wherein the mobile computing device is configured to switch between the different orientation modes upon a satisfaction of a predefined condition;
determining a flow direction of the media content;
detecting, via the touch-sensitive screen while the media content is displayed, a plurality of inputs made by a user, the plurality of inputs each having a directional component;
determining a common directional component for a majority of the detected inputs; and
adjusting the condition in response to the common directional component being consistent with the flow direction of the media content.

2. The method of claim 1, wherein the adjusting the condition comprises making the satisfaction of the condition more difficult.

3. The method of claim 1, further comprising:
measuring a tilt of the mobile computing device;
comparing the measured tilt of the mobile computing device with a predetermined tilt threshold; and
determining that the condition has been satisfied when the measured tilt of the mobile computing device has exceeded the predetermined tilt threshold.

4. The method of claim 3, wherein the adjusting the condition comprises increasing the predetermined tilt threshold so that it is more difficult to be exceeded.

5. The method of claim 1, wherein the inputs include swiping gestures.

6. The method of claim 1, wherein the displaying the media content comprises displaying a web page or an electronic book.

7. The method of claim 1, wherein the determining the common directional component is performed with respect to the detected inputs after a most recent switching of the orientation mode.

8. The method of claim 1, further comprising:
detecting, after the condition has been adjusted, the satisfaction of the condition;
switching from one of the portrait and landscape orientation modes to the other of the portrait and landscape orientation modes in response to the detected satisfaction of the condition; and
thereafter resetting the condition to the predefined condition.

9. The method of claim 1, further comprising:
detecting the satisfaction of the condition while the media content is displayed at a first orientation mode, the first orientation mode being one of the portrait orientation mode and the landscape orientation mode;
displaying, in response to the satisfaction of the condition, the media content in a second orientation mode different from the first orientation mode, the second orientation mode being another one of the portrait orientation mode and the landscape orientation mode; detecting, within a predetermined amount of time after the media content is displayed in the second orientation mode, a satisfaction of the condition to switch from the second orientation mode back to the first orientation mode; and
thereafter performing the following:
displaying the media content in the first orientation mode; and
adjusting the condition in a manner so that the switching from the first orientation mode to the second orientation mode is more difficult.

10. The method of claim 9, wherein the predetermined amount of time is less than a few seconds.

11. A method, comprising:
displaying media content via a screen of a mobile computing device, wherein the displaying is performed so that the media content is displayed in a first orientation mode;
detecting a first satisfaction of a predefined condition;
displaying, in response to the detected first satisfaction of the predefined condition, the media content in a second orientation mode different from the first orientation mode, wherein the one of the first and second orientation modes is a portrait orientation mode, and the other one of the first and second orientation modes is a landscape orientation mode;
detecting a second satisfaction of the predefined condition immediately after the media content has been displayed in the second orientation mode;
displaying, in response to the detected second satisfaction of the predefined condition, the media content in the first orientation mode; and
thereafter adjusting the predefined condition in a manner so that it is more difficult to satisfy.

12. The method of claim 11, wherein the predefined condition specifies a threshold tilt angle of the mobile computing device.

13. The method of claim 12, wherein the first satisfaction of the predefined condition includes detecting that the mobile computing device has been tilted at an angle that exceeds the threshold tilt angle of the mobile computing device.

14. The method of claim 11, wherein the displaying the media content comprises displaying a web page, an electronic book, a picture, a video, or a game.

15. The method of claim 11, wherein the mobile computing device comprises a smartphone or a tablet computer each having a touch-sensitive user interface.

16. A mobile computing device, comprising:
a screen configured to display media content;
a computer memory storage module configured to store executable computer programming code; and
a computer processor module operatively coupled to the computer memory storage module, wherein the computer processor module is configured to execute the computer programming code to perform the following operations:
displaying media content via the screen in a first orientation mode;
detecting a first satisfaction of a predefined condition;
displaying, in response to the detected first satisfaction of the predefined condition, the media content in a second orientation mode different from the first orientation mode, wherein the one of the first and second orientation modes is a portrait orientation mode, and the other one of the first and second orientation modes is a landscape orientation mode;
detecting a second satisfaction of the predefined condition immediately after the media content has been displayed in the second orientation mode;
displaying, in response to the detected second satisfaction of the predefined condition, the media content in the first orientation mode; and
thereafter adjusting the predefined condition in a manner so that it is more difficult to satisfy.

17. The mobile computing device of claim 16, wherein the predefined condition specifies a threshold tilt angle of the mobile computing device.

18. The mobile computing device of claim 17, wherein the satisfaction of the predefined condition includes detecting that the mobile computing device has been tilted at an angle that exceeds the threshold tilt angle of the mobile computing device.

19. The mobile computing device of claim 16, wherein the displaying the media content comprises displaying a web page or an electronic book.

20. The mobile computing device of claim 16, wherein the mobile computing device comprises a smartphone or a tablet computer, and wherein the screen is a touch-sensitive screen.
